(19) United States
(12) Patent Application Publication
(10) Pub. No.: US 2025/0350413 A1
(43) Pub. Date: Nov. 13, 2025

(54) SYSTEMS, METHODS AND APPARATUS FOR PARTIAL LONG TRAINING SEQUENCE (LTS) USING DISTRIBUTED RESOURCE UNIT (DRU) TONE PLAN

(71) Applicant: HUAWEI TECHNOLOGIES CO., LTD., SHENZHEN (CN)

(72) Inventors: Jung Hoon SUH, Kanata (CA); Yan XIN, Kanata (CA); Osama ABOUL-MAGD, Kanata (CA); Sara NOROUZI, Kanata (CA); Mahmoud Ahmed Mohammed HASABELNABY, Kanata (CA)

(73) Assignee: HUAWEI TECHNOLOGIES CO., LTD., SHENZHEN (CN)

(21) Appl. No.: 18/815,029

(22) Filed: Aug. 26, 2024

Related U.S. Application Data
(60) Provisional application No. 63/644,274, filed on May 8, 2024.

(51) Int. Cl. H04L 5/00

(52) U.S. Cl. CPC H04L 5/001; H04L 5/0048

(57) ABSTRACT

Embodiments of the present application provides system, methods and apparatus for partial long training sequence (LTS) using DRU tone plan. An orthogonal frequency division multiple access (OFDMA) frame is transmitted using a plurality of DRUs. The frame includes a scattered long training field (SLTF) portion which furthers includes one or more orthogonal frequency division multiplexing (OFDM) symbols. Each of these symbols carries a portion of the LTS using a respective DRU. At least two different OFDM symbols use different respective DRU to carry the LTS portion. Each of these symbols further carries data using another respective one or more DRUs. Transmission of this frame may inhibit LTF overhead and may allow for transmitting increased data size.

### CROSS-REFERENCE TO RELATED APPLICATIONS

This application claims priority to U.S. Patent Application No. 63/644,274, filed May 8, 2024, the contents of which are incorporated herein by reference.

### FIELD OF THE APPLICATION

The present application pertains to the field of wireless communication systems, and in particular to systems, methods and apparatus for communicating training sequences.

### BACKGROUND

Wi-Fi™ 8 (IEEE 802.11bn, ultra-high reliability (UHR)) communication systems are being developed to improve wireless communication performance over previous Wi-Fi™ systems. One potential feature of such systems is the use of distributed resource units (DRUs) which includes a set of tones (also referred to as subcarriers) that may be allocated across a bandwidth that is greater than a bandwidth of the aggregate set of tones. The tones of different DRUs may be fully or partially interleaved with one another to form multiple non-contiguous sets of tones.

Training sequences, such as long training sequences (LTS) included in long training fields of IEEE 802.11 frames, are employed for purposes such as channel estimation and channel equalization. A frame can include such sequences and fields which can be used for demodulation of the rest of the frame. However, to date, proposals for the coexistence of long training sequences and DRUs are subject to improvement. For example, the integration of LTS and DRUs in an efficient or synergistic manner is subject to improvement.

Therefore, there is a need for methods, systems and apparatus for providing long training sequences using DRU tone plans, for WLANs, such as in Wi-Fi™ systems, that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The present disclosure provides systems, apparatus and methods related to communicating partial LTS using DRU tone plans. According to a first aspect, a method is provided for transmitting data in a Wireless Local Area Network (WLAN). The method may be performed by an electronic device. The method includes transmitting an orthogonal frequency division multiple access (OFDMA) frame utilizing a plurality of distributed resource units (DRUs). Each DRU of the plurality of DRUs includes a respective group of subcarriers spread across a predetermined bandwidth of the OFDMA frame. The plurality of DRUs is interleaved with one another in frequency. The OFDMA frame includes a scattered long training field (SLTF) portion which includes one or more orthogonal frequency division multiplexing (OFDM) symbols arranged sequentially in time. Each of the OFDM symbols is formed using the plurality of DRUs. Each of the OFDM symbols carries, using a respective one of the DRUs, a respective portion of a long training sequence (LTS) of a long training field (LTF) of the OFDMA frame, and carries data using another respective one or more of the DRUs. According to at least some embodiments, at least two different symbols of the OFDM symbols use different respective ones of the DRUs for carrying the respective portions of the LTS. In other embodiments, all of the OFDM symbols may use a same one of the DRUs for carrying their respective portions of the LTS. The method may inhibit LTF overhead that is created due to increased number of LTFs. The method may further allow for increased data size transmission.

In some embodiments, within each respective one of the OFDM symbols, an m^{th} one of the DRUs carries a respective portion of the LTS. The m^{th} DRU is determined according to the formula: m=mod(n−1,M)+1. In the formula n represents a time-sequential position of the respective one of the OFDM symbols within the (e.g. plurality of) OFDM symbols and M represents a total number of the DRUs used in the OFDM frame. Further, m represents a position within a frequency-based ordering of the plurality of DRUs, such that adjacency of two DRUs in the frequency-based ordering corresponds to adjacency, in frequency, of constituent subcarriers of the two DRUs.

In some embodiments, the LTS is formed of a plurality of sequential portions each represented as LTSₖ, with k indexed beginning from 0. In some embodiments, for each k, LTSₖ is carried by a k+1^{st} one of the subcarriers, the subcarriers being ordered sequentially in frequency. In some embodiments, the LTS is repeated according to a (same) pattern, each repetition being carried by a separate respective group of the OFDM symbols.

In some embodiments, the OFDMA frame further includes a pure data portion in including one or more further OFDM symbols carrying data and being devoid of contents of the LTF. In some embodiments, the (e.g. plurality of) OFDM symbols carrying portions of the LTS collectively establish a time-frequency pattern of DRUs according to those DRUs carrying portions of the LTS. This time-frequency pattern is carried over into the pure data portion to define a set of unused DRUs within the one or more further OFDM symbols of the pure data portion.

In some embodiments, transmit power per tone is increased for the one or more further OFDM symbols in response to the unused DRUs. Embodiments may allow for increased transmit power, thereby improving transmission range. In some embodiments, substantially all data of the OFDMA frame is carried within the SLTF portion. Embodiments may further allow increased data size transmission.

In some embodiments, the LTS is repeated. In some embodiments, where the LTS is repeated, at least some different instances of the repeated LTS are multiplied by different corresponding entries within a P-matrix or an extended P-matrix. More generally, each repetition of the LTS can be varied in a manner known to both transmitter and receiver, for example by multiplying all components of a given repetition by a value such as “+1” or “−1.” Embodiments may allow for improved accuracy of channel estimation by extending the scattered LTF portion.

In some embodiments, the one or more OFDM symbols include a first symbol. The first symbol includes a first DRU carrying a portion of the LTS and one or more DRUs other than the first DRU carrying data. In some embodiments, the one or more OFDM symbols further include a second symbol. The second symbol includes a second DRU different from the first DRU, the second DRU carrying another portion of the LTS and one or more DRUs other than the second DRU carrying data.

According to another aspect, an apparatus is provided, where the apparatus includes modules configured to perform one or more methods described herein. According to another aspect, another apparatus is provided that includes computing electronics and is configured to perform the methods described herein. According to another aspect, another apparatus is provided that includes processing and wireless communication electronics and is configured to operate as described herein. According to another aspect, a system is provided that includes one or more apparatuses as described herein.

For example, according to an aspect, there is provided an apparatus, in an IEEE 802.11 transmitter. The apparatus is configured to transmit an orthogonal frequency division multiple access (OFDMA) frame utilizing a plurality of distributed resource units (DRUs) each comprising a respective group of subcarriers spread across a predetermined bandwidth of the OFDMA frame, the plurality of DRUs interleaved with one another in frequency. The OFDMA frame includes a scattered long training field (SLTF) portion which includes one or more orthogonal frequency division multiplexing (OFDM) symbols arranged sequentially in time. Each of the OFDM symbols is formed using the plurality of DRUs. Each of the OFDM symbols carries, using a respective one of the plurality of DRUs, a respective portion of a long training sequence (LTS) of a long training field (LTF) of the OFDMA frame, and carries data using another respective one or more of the plurality of DRUs. In various embodiments, at least two different symbols of the OFDM symbols use different respective ones of the plurality of DRUs for carrying the respective portions of the LTS.

According to another aspect, an apparatus is provided, where the apparatus includes: a memory, configured to store a program; a processor, configured to execute the program stored in the memory, and when the program stored in the memory is executed, the processor is configured to perform the methods in the different aspects described herein.

According to another aspect, a method is provided for execution by processing and wireless communication electronics. The method includes performing operations as described herein. In some embodiments a computer program product is provided. The computer program product includes a non-transitory computer readable medium having recorded thereon statements and instructions which, when executed by a computer, cause the computer to perform one or more methods described herein.

According to another aspect, a chip or chipset is provided, where the chip or chipset includes a processor and a data interface, and the processor reads, by using the data interface, an instruction stored in a memory, to perform the different aspects described herein. The apparatus as described above may be or may include such a chip or chipset.

Other aspects of the application provide for apparatus, and systems configured to implement the methods according to the different aspects disclosed herein. For example, wireless stations and access points can be configured with machine readable memory containing instructions, which when executed by the processors of these devices, configures the device to perform the methods disclosed herein.

Embodiments have been described above in conjunction with aspects of the present application upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present application will become apparent from the following detailed description, taken in combination with the appended drawings, in which:

FIG. 1 illustrates an OFDMA frame with scattered LTFs, according to an embodiment of the present application.

FIG. 2 illustrates fixed LTS positioned across the entire scattered UHR-LTFs, according to an embodiment of the present application.

FIG. 3 illustrates a configuration involving 4 Scattered Long Training Fields (SLTF) based on 52-tone DRUs with 16 data symbols, according to an embodiment of the present application.

FIG. 4 illustrates a configuration involving 8 SLTF based on 52-tone DRUs with 16 data symbols, according to an embodiment of the present application.

FIG. 5 illustrates a configuration involving 16 SLTFs based on 52-tone DRUs with 16 data symbols, according to an embodiment of the present application.

FIG. 6 illustrates a configuration involving 2 SLTFs based on 106-tone DRUs with 16 data symbols, according to an embodiment of the present application.

FIG. 7 illustrates a configuration involving 4 SLTFs based on 106-tone DRUs with 16 data symbols, according to an embodiment of the present application.

FIG. 8 illustrates a configuration involving 8 SLTF based on 106-tone DRUs with 16 data symbols, according to an embodiment of the present application.

FIG. 9 illustrates a configuration involving 16 SLTF based on 106-tone DRUs with 16 data symbols, according to an embodiment of the present application.

FIG. 10 illustrates performance of several staggered LTFs with 12 52-tone DRU based data symbols in a SISO configuration over variable channel condition, according to an embodiment of the present application.

FIG. 11 illustrates performance of several staggered LTFs with 8 106-tone DRU based data symbols in a SISO configuration over variable channel condition, according to an embodiment of the present application.

FIG. 12 illustrates a performance comparison between staggered LTFs with regular LTFs (R-LTFs) in a SISO configuration over variable channel condition, according to an embodiment of the present application.

FIG. 13 illustrates a method for transmitting data in a Wireless Local Area Network (WLAN) according to an embodiment of the present application.

FIG. 14 is a schematic diagram of an electronic device that may perform any or all of operations of the above methods and features explicitly or implicitly described herein, according to different embodiments of the present application.

FIG. 15 illustrates a communication system, according to an embodiment of the present application.

FIG. 16A illustrates an example apparatus, according to an embodiment of the present application.

FIG. 16B illustrates another example apparatus, according to an embodiment of the present application.

It will be noted that throughout the appended drawings, like features are identified by like reference numerals.

### DETAILED DESCRIPTION

The introduction of the DRU in IEEE 802.11 ultra high reliability (UHR) systems (e.g. IEEE 802.11bn, Wi-Fi 8) marks a notable advancement. The power spectral density (PSD) requirement set by the Federal Communications Commission (FCC) regulation imposes an upper bound on TX power at every 1 Megahertz (MHz). Embodiments of the present disclosure pertain to such IEEE 802.11 systems, for example as specified by the appropriate working group(s).

Within the DRU framework, subcarriers in each Resource unit (RU) can span or be allocated across the entire Bandwidth (BW) of the frame, allowing each RU to use the full frame bandwidth regardless of RU size, known as a DRU. In contrast, a Regular RU (RRU) only occupies a sub-bandwidth according to its RU size. This application of FCC's PSD regulation is based on the frame's BW where DRU-based orthogonal frequency division multiple access (OFDMA) is scheduled, particularly benefiting uplink (UL) OFDMA PHY protocol data unit (PPDU) transmissions.

While the DRU has shown limited benefit to DL OFDMA transmission, embodiments may provide technical advantages to downlink (DL) OFDMA transmission by leveraging the DRU scheme. Embodiments may be applied in the UL direction, DL direction, or both.

As may be appreciated, the reference signal used for Wireless Local Area Network (WLAN) channel estimation, known as the long training field (LTF), occupies the entire symbol (OFDM symbol). This leads to significant overhead when increasing the number of LTF symbols to enhance channel estimation accuracy. Embodiments may provide for occupying or using a subset or a portion of the sub-carriers within a symbol to transmit the LTF. Embodiments may further provide for using the remaining portion of the sub-carriers for data transmission. This partial occupation may allow for more efficient use of resources while still providing the necessary reference signal for channel estimation or other purposes.

As used herein, the term “symbol” typically refers to an OFDM symbol. The OFDM symbol can be formed using multiple modulated subcarriers, also referred to as tones. Each tone can be modulated according to an individual modulation symbol, such as a quadrature amplitude modulation (QAM) symbol.

The existing solutions fail to adequately resolve the challenges posed by the distributed resource unit (DRU) in downlink scenarios. This lack of a remedy not only leaves the issue of DRU inefficiency unresolved but also amplifies the complexities and overhead associated with integrating DRU functionalities into downlink operations.

The heretofore existing DL OFDMA transmission does not leverage the TX boost provided by the DRU. Moreover, the existing LTF setup results in increased overhead when scaling up the number of LTFs to improve channel estimation accuracy, for example, for serving devices over longer distances.

According to an embodiment, a subset or a portion of subcarriers within a symbol is allocated for transmitting the LTF using the DRU tone plan. The rest of the subcarriers in that symbol can then be utilized for transmitting data. This approach may help address the overhead associated with the LTF.

Furthermore, in some embodiments, the channel parameters for all subcarriers can be derived by interpolating or smoothing the information obtained from the partially occupied LTS. Some embodiments may obviate the need for interpolation for estimating channel parameters for the entire range of subcarriers.

Embodiments may be applicable for downlink OFDMA or UL Single User (SU) transmission. One or more embodiments may be applicable for communicating with Internet of Things (IoT) devices over long distances while using relatively short packet sizes. One or more embodiments may apply to Wi-Fi™ 8 access points (AP) or devices (e.g. STAs), intended for future technology or devices.

Various approaches or methods may be provided for sporadically dispersed LTS within a symbol and expanding the number of LTFs. Embodiments may offer different methods for repeating LTFs to extend their number.

Channel estimation is performed at the receiver (RX) side to facilitate channel equalization in both Single-Input Single-Output (SISO) and Multiple-Input Multiple-Output (MIMO) configurations. Typically, the number of LTFs (LTF symbols) required aligns with (e.g., is proportionate to) the number of Spatial Streams (SS) transmitted; for instance, if two SS are transmitted, two LTFs are typically needed.

However, it's possible to enhance channel estimation accuracy by using more LTFs than necessary. For example, employing 4, 8, or even 16 LTFs for a transmission with 2 SS can improve channel estimation capability. Yet, this approach can introduce LTF overhead, particularly when the number of LTFs exceeds the scheduled SS count. To manage this, the IEEE 802.11 TGbe standard allows for but limits the number of LTFs to twice the scheduled SS count when employing an extended number of LTFs.

According to an embodiment, the subcarriers corresponding to only one of the DRUs scheduled in an OFDM symbol are utilized for the LTS, while the remaining tones (subcarriers) are allocated for data scheduling. This approach may reduce the long training field (LTF) overhead. In some embodiments, a symbol or an OFDM symbol may refer to a scattered LTF (SLTF) symbol, a data symbol, or a pure data portion symbol. A scattered LTF (SLTF) symbol may refer to a scattered UHR-LTF symbol. A SLTF symbol may include LTF information as well as data, for example as carried via different DRUs of the symbol.

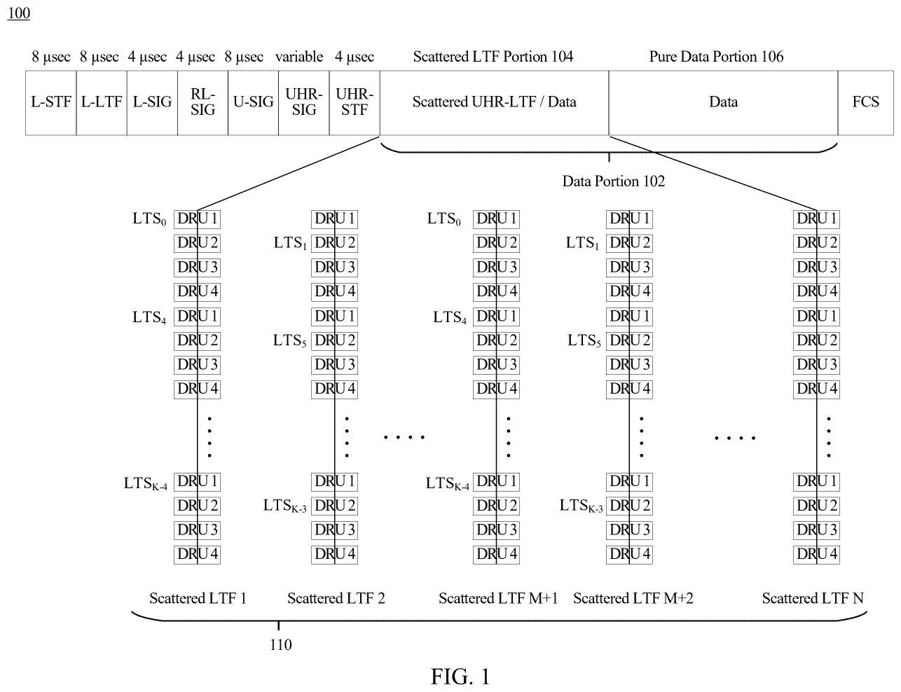

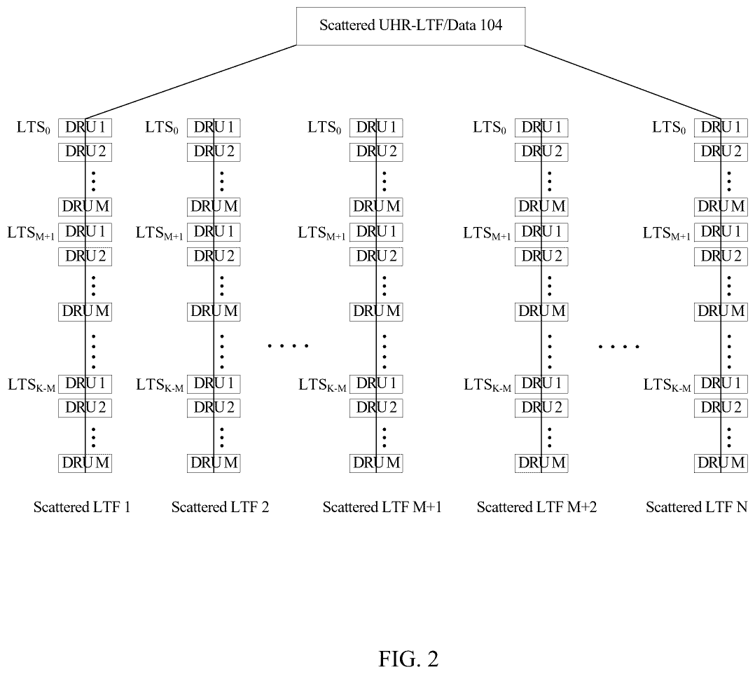

According to an embodiment, staggered LTFs are introduced for the scattered LTF portion of a frame. In an embodiment, LTS occupies subcarriers in a staggered manner within symbols, without utilizing the same tones in every symbol. For a staggered LTF, the LTS are allocated to different DRUs (and their corresponding subcarriers) in different OFDM symbols. The allocation pattern can be repeated and follow a diagonal pattern in illustrated embodiments described herein. Accordingly, different OFDM symbols use different DRUs to carry LTS portions. FIG. 1 illustrates a staggered configuration, while FIG. 2 illustrates a non-staggered configuration (also referred to as a fixed configuration, e.g. with fixed positions of the LTS portions with respect to DRUs). A scattered LTF can be implemented using a staggered configuration or a non-staggered configuration, for example.

FIG. 1 illustrates an OFDMA frame with scattered LTFs, according to an embodiment. The frame 100 may refer to a frame used in Wi-Fi networks. The format of the frame 100 may vary and may include one or more fields indicating: a Legacy STF (L-STF), a legacy LTF (L-LTF), a legacy signal (L-SIG) field, a repeated legacy signal (RL-SIG), a universal signal (U-SIG), a UHR-SIG, a UHR-STF and a Frame Check Sequence (FCS). In some embodiments, the frame 100 further includes a Data Portion Field 102. The Data Portion Field 102 may further include one or both of a Scattered LTF (SLTF) Portion 104 and a Pure Data Portion 106.

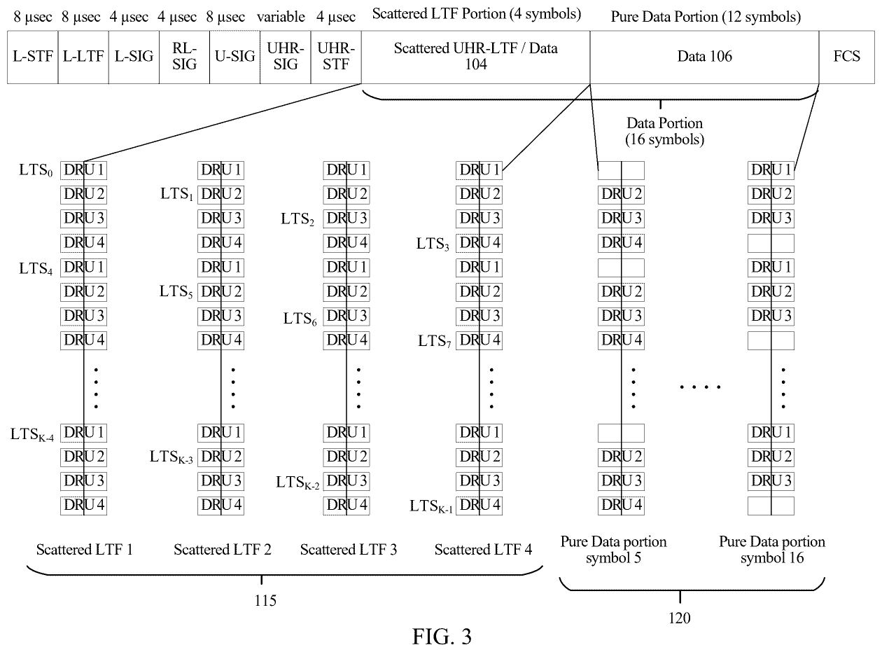

In some embodiments, the Data Portion 102 includes the scattered LTF portion 104 as illustrated. A Pure Data Portion 106 may be distinguished from the data portion 102 as shown. The pure data portion may include only pure data portion symbols (symbols 120 in FIG. 3), where data portion 102 may include one or more of: pure data portion symbols 120 and SLTF symbols 110 (or SLTF symbols 115 in FIG. 3). Generally, the frame includes a plurality of OFDM symbols. Each of these OFDM symbols includes a plurality of DRUs (and their constituent tones or subcarriers) transmitted concurrently. For example, in FIGS. 1 to 9, each column of DRUs, such as the column corresponding to Scattered LTF 1, Scattered LTF 2, Pure data portion symbol 5, etc. is an instance of an OFDM symbol. Thus, as used herein, SLTF symbols and pure data portion symbols are types of OFDM symbols. OFDM symbols are illustrated for example as SLTF symbols 110, 115, or as pure data portion symbols 120.

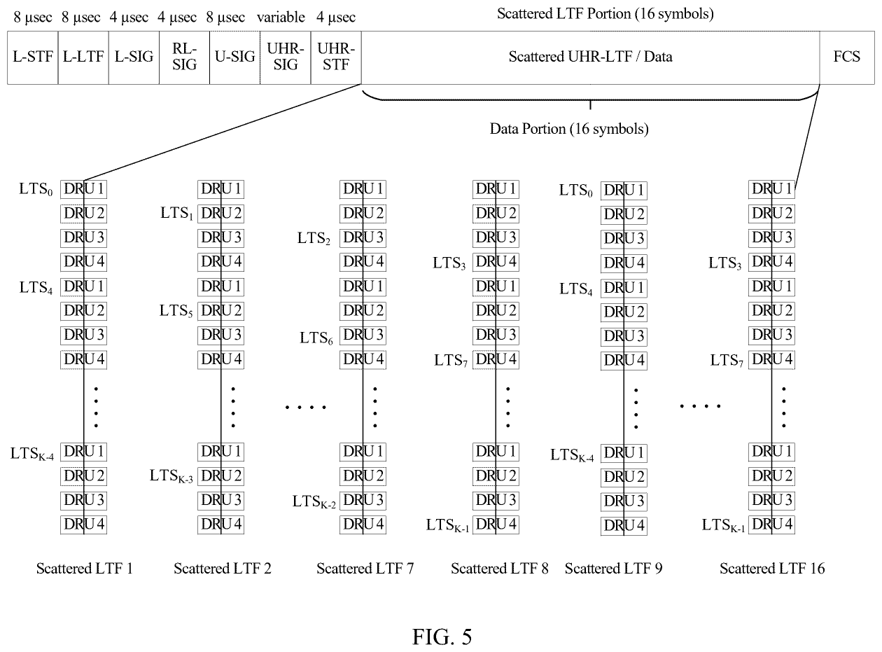

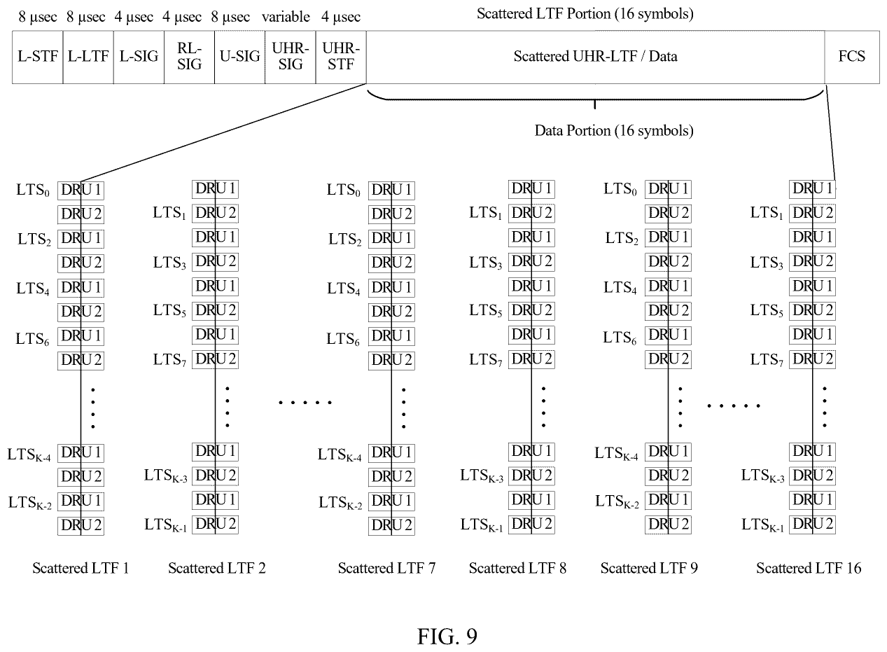

In some embodiments, the Scattered LTF Portion 104 can extend up to where the Pure Data Portion 106 ends (as illustrated in FIG. 5 and FIG. 9 for example). Thus, the Pure Data Portion may be omitted in some embodiments, so that the SLTF portion carries substantially all the data. The SLTF portion may therefore carry a mixture of training symbols and data. In some embodiments, the number of scattered LTF symbols is equal to or more the number of SSs. As may be appreciated, in some embodiments, the number of scattered LTF symbols may depend on the applicable Wi-Fi standards.

In some embodiments, the value K in FIG. 1 represents the length of the LTS in an OFDM symbol and per BW (such that the length of the LTS depends on the BW). The LTS are indexed by lowercase k. In some embodiments, the maximum value for the index variable k (indexed starting from zero) can be K−1, that is the length of the LTS can be K. In some embodiments, the LTS is non-zero LTS which excludes the direct current (DC) and Edge tones. In some embodiments, e.g., in Wi-Fi 6 and 7, the length of non-zero LTS is 242 (256−3 DC−11 Edge) in 20 MHz. In some embodiments, the tone plan may vary, for example, in future Wi-Fi technology.

In some embodiments, the frame 100 utilizes a plurality of DRUs as illustrated. Each DRU includes a respective group of subcarriers spread across a predetermined bandwidth of the frame, the plurality of DRUs interleaved with one another in frequency. The different DRUs can be at least partially interleaved with one another as part of such spreading.

In some embodiments, the SLTF portion 104 includes one or more OFDM symbols (e.g., SLTF symbols 110) arranged sequentially in time. In some embodiments, each of the OFDM symbols is formed using the plurality of DRUs. In some embodiments, each of the OFDM symbols carries, using a respective one of the DRUs, a respective portion of an LTS of the LTF of the frame. For example, referring to FIG. 1, the first SLTF (scattered LTF 1) carries an LTS at the first DRU. The first DRU comprises the first subcarrier and every fourth subsequent subcarrier after the first subcarrier, as illustrated (i.e. subcarriers 1, 5, 9, etc.). In some embodiments, each of the OFDM symbols carries data using another respective one or more of the DRUs. For example, the first SLTF may carry data in one or more DRUs including DRU 2, DRU 3 and DRU4, each of which comprises a second, third, or fourth initial subcarrier, respectively, and every fourth subsequent subcarrier counting from this initial subcarrier of said DRU 2, DRU 3 and DRU 4. Accordingly, a DRU may be formed from multiple evenly-spaced subcarriers, interleaved with other subcarriers of other DRUs. DRU k is formed of the k^{th} subcarrier, k+4^{th} subcarrier, k+8^{th} subcarrier, etc.

In some embodiments, at least two different symbols of the (e.g. plurality of) OFDM symbols use different respective ones of the DRUs for carrying the respective portions of the LTS. For example, the first SLTF carries an LTS in the first DRU and the second SLTF (scattered LTF 2) carries an LTS in the second DRU, as illustrated. The first DRU (DRU 1) in turn includes multiple subcarriers as described above, the second DRU (DRU 2) includes its own multiple subcarriers as also described above.

In some embodiments, within each respective one of the OFDM symbols (e.g., SLTF symbols 110), an m^{th} one of the DRUs carries a respective portion of the LTS, where m=mod(n−1,M)+1. Where n represents a time-sequential position of the respective one of the OFDM symbols within the (e.g. plurality of) OFDM symbols, and M represents a total number of the DRUs used in the OFDM frame. Further, m represents a position within a frequency-based ordering of the plurality of DRUs, such that adjacency of two DRUs in the frequency-based ordering corresponds to adjacency, in frequency, of constituent subcarriers of the two DRUs.

In some embodiments, the LTS is formed of a plurality of sequential portions each represented as LTSₖ, with k indexed beginning from 0. Further, for each k, LTSₖ is carried by a k+1^{st} one of the subcarriers, the subcarriers being ordered sequentially in frequency. For example, in the first SLTF, for k=0, referring to LTS₀, the LTS portion is carried in the k+1st, i.e. the first one of the subcarriers, referring to DRU 1 as illustrated.

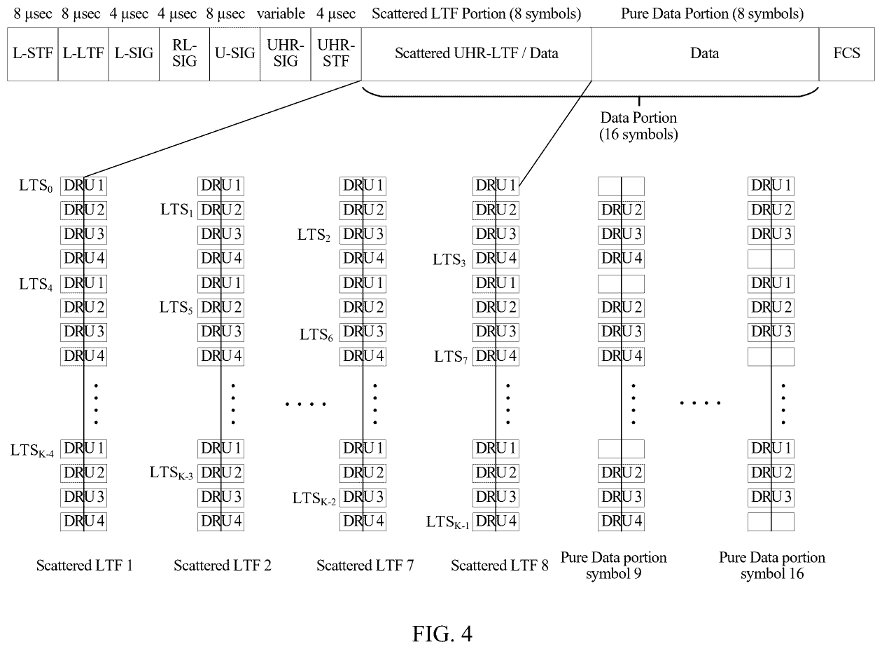

In some embodiments, the LTS is repeated according to a pattern, i.e. a same pattern which repeats. Each repetition is carried by a separate respective group of the OFDM symbols. For example, in FIG. 4, the LTS pattern of the SLTF 1 to SLTF 4 (a first group of four OFDM symbols) are repeated once, being repeated in SLTF 5 to SLTF 8 (a second group of four OFDM symbols). That is, each of SLTFs 1 to 4 will have LTS portions in the same DRUs as each of SLTFs 5 to 8, respectively (e.g. SLTF 5 will have LTS₀, LTS₄, etc. carried by DRU1). Similarly in FIG. 5, the LTS pattern of the SLTF 1 to SLTF 4 are repeated in each subsequent set of 4 SLTFs for a total of 16 SLTFs, with the LTS pattern being repeated 4 times, i.e. with SLTFs 1 to 4 having the same pattern as each block of four SLTFs 5 to 8, 9 to 12 and 13 to 16.

In some embodiments, the pure data portion 106 includes one or more further OFDM symbols carrying data and being devoid of contents of the LTF. For example, in FIG. 3, the pure data portion 106 includes one or more OFDM symbols (e.g., pure data portion symbol 120). Each of the pure data portion symbols 120 includes a plurality of DRUs, and one or more DRUs are used to carry data while one or more other DRUs remain devoid of data as illustrated. The allocation of these empty or blank DRUs are based on the LTS allocation within a corresponding SLTF. For example, in FIG. 3, in pure data portion symbol 5, DRUs 2, 3, and 4 are used to carry data, whereas DRU 1 is left blank. This leaving of DRU 1 blank is based on the LTS, of DRU 1 of the corresponding SLTF 1 being used for conveying the LTF. The same pattern of blank DRU 1 and data DRU 2, 3 and 4 is then repeated for the remaining DRUs of the pure data portion symbol 5. That is, the SLTF portion establishes a pattern of DRUs used to conveying the LTF, and this pattern repeats to define DRUs in the pure data portion which are left blank. The pattern may refer to the time-frequency pattern, as described below, extended from the SLTF portion into the pure data portion. The pattern may be “inverted” between the SLTF portion and the pure data portion, in the sense that, in the SLTF portion the pattern defines tones used to convey the LTF, whereas in the pure data portion the pattern defines tones which are unused to convey data. In some embodiments, a transmitter may implement a blank DRU within an OFDM symbol by refraining from transmitting energy on the subcarriers allocated to that blank DRU. In some embodiments, a blank DRU may be used for another purpose, e.g. to transmit data, in a manner that may not be specified herein. Where blank DRUs are present, the transmit power of the other tones of the same OFDM symbol can be increased, as discussed below.

In some embodiments, the pure data portion uses all DRUs (i.e., no blank DRUs) for carrying data. Accordingly, one or more OFDM symbols of the pure data portion 106 carries data in all its DRUs.

In some embodiments, the (e.g. plurality of) OFDM symbols (e.g., SLTF symbols 110 or 115) carrying portions of the LTS collectively establish a time-frequency pattern of DRUs according to those DRUs carrying portions of the LTS, this time-frequency pattern being carried over into the pure data portion to define a set of unused DRUs within the further OFDM symbols (e.g., pure data portion symbol 120) of the pure data portion. The time-frequency pattern may be a repeating “diagonal” or “checkerboard” pattern for example as specified by the formula m=mod(n−1,M)+1 as described elsewhere herein. In this case, the values of n continue so as to index past the SLTF portion into the pure data portion. For example, in FIG. 3, the LTS allocation pattern in SLTF 1 is used to determine the set of unused or blank DRUs of the corresponding pure data portion symbol 5. Similarly, the LTS allocation pattern in SLTF 4 is used to determine the set of unused or blank DRUs of the corresponding pure data portion symbol 16 as illustrated. Note that in the pattern a single tone or DRU allocated for carrying an LTS part or being left blank may be followed, in the same OFDM symbol, by multiple tones or DRUs which are unallocated for same. Because in the SLTF portion, certain DRUs are used to carry LTS portions and thus are unused to carry data, and other DRUs are used to carry data, this approach allows this pattern (of certain DRUs unused to carry data and other DRUs used to carry data) to continue into the pure data portion. In this way a single cohesive pattern, by which DRUs carrying data and DRUs not carrying data can be identified, is established.

In some embodiments, the transmit (TX) power per tone is increased for the further OFDM symbols in response to the unused DRUs. That is, when some tones or DRUs are unused in transmission (carry no RF energy), the transmit power for the other tones of the same OFDM symbol can be increased while still respecting regulatory requirements. For example, in FIG. 3, the per-tone TX power is increased from Pₜ/4 to Pₜ/3, where Pₜ represents the TX power being used for every 4 sub-carriers. In some embodiments, substantially all data of the frame is carried within the SLTF portion. For example, in FIG. 5 and FIG. 9, the SLTF portion extends to 16 symbols encompassing the entire data portion.

In some embodiments, LTS or the pattern of LTS is repeated. In some embodiments, where the LTS is repeated, at least some different instances of the repeated LTS are multiplied by different corresponding entries within a P-matrix or an extended P-matrix.

In some embodiments, the one or more OFDM symbols include a first symbol having a first DRU carrying a portion of the LTS and one or more DRUs other than the first DRU carrying data. For example, in FIG. 3, SLTF 1 (as an OFDM symbol) has DRU 1 carrying a portion of the LTS, e.g., LTS₀, LTS₄, etc. and DRU 2, 3 and 4 are used to carry data. Further the pattern of LTS portion at DRU 1 and data at DRU 2, 3, 4 is applied to all tones of SLTF 1. That is, tones 1, 5, 9, etc. convey LTS and tones 2-4, 6-8, etc. carry data.

In some embodiments, the one or more OFDM symbols include a second symbol having a second DRU different from the first DRU, the second DRU carrying another portion of the LTS and one or more DRUs other than the second DRU carrying data. For example, in FIG. 3, SLTF 2 has DRU 2 carrying a portion of the LTS, e.g., LTS₁, LTS₅, etc. and DRU 1, 3, and 4 are used to carry data. Further the pattern of LTS portion at DRU 2 tones and data at DRU 1, 3, 4 tones is applied to all tones of SLTF 2 as illustrated.

According to an embodiment, a method is provided where the tones corresponding (only) to given distributed resource unit (DRU) are occupied with the LTS in a respective scattered LTF symbol. For example, in the first scattered LTF symbol, tones (subcarriers) corresponding to DRU 1 are occupied with the LTS; in the second scattered LTF symbol, tones corresponding to DRU 2 are occupied with the LTS; in the third scattered LTF symbol, tones corresponding to DRU 3 are occupied with the LTS, and this pattern continues for other DRUs in subsequent scattered LTF symbols.

Once the LTS allocation pattern consumes the same size of DRUs within a PPDU BW, the LTS allocation pattern can be repeated from the first scattered LTF symbol. For instance, in FIG. 1, if the DRU size is a 52-tone DRU in a 20 MHz BW, and M is set to 4, the LTS allocation pattern can be repeated. If there are 8 scattered UHR-LTF symbols, the LTS allocation pattern is repeated once to obtain 8 SLTF symbols.

In some embodiments, at a receiver, interpolation (or smoothing) is applied to recover the channel parameters in each scattered UHR-LTF symbol across all sub-carriers right after the Fast Fourier Transform (FFT) operation and just before the MIMO channel estimation process, which requires the product between the P-matrix transpose and LTF symbols.

According to an embodiment, fixed DRU positions are utilized for allocating or occupying the partial LTS within a symbol. In some embodiments, tones corresponding to a specific DRU are occupied with the LTS across all scattered LTF symbols. For example, only the DRU k (e.g., DRU 1, DRU 2, . . . , or DRU M if there are M same-sized DRUs in a PPDU bandwidth) is occupied with the LTS, while the remaining DRUs are scheduled with the data. This may be applicable to all scattered LTF (OFDM) symbols.

FIG. 2 illustrates fixed LTS positioned across the entire scattered UHR-LTFs, according to an embodiment. In some embodiments, the LTS position of the Scattered LTF portion 104 is fixed. For example, as illustrated, the LTS is assigned only to the tone position(s) of DRU 1. In other such embodiments, the LTS may be carried only by the subcarriers of another DRU (or more than one DRU), e.g. DRU k where k is a value from 1 to M.

In the embodiment of FIG. 2, one fewer station (STA) is scheduled compared to the embodiment of FIG. 1, yet its implementation is simpler due to the fixed position of the LTS as illustrated.

In some embodiments, channel parameters for all subcarriers are recovered by running an interpolation (or smoothing) algorithm after the FFT operation across all tones. Additionally, the channel estimation operation occurs at the tone position where the LTSs are allocated, which is the DRU 1 tone position in FIG. 2. This differs from the channel estimation in the embodiment of FIG. 1, where the interpolation (or smoothing) algorithm is applied after the FFT operation and before the channel estimation.

In some embodiments, the data carried in the SLTF portion 104 is buffered at the receiver side until channel estimation is performed. After buffering, the data can be demodulated after the channel estimation and channel equalization.

In some embodiments, methods are provided for repeating the scattered UHR-LTF symbols (extending the scattered UHR-LTF portion or scattered LTF portion). Some embodiments may provide methods for extending the scattered UHR-LTF up to the packet length.

According to an embodiment, a method for extending the scattered UHR-LTF is based on applying the extended P-matrix size as far as to the symbol length of Scattered UHR-LTF. Accordingly, in some embodiments, extending the scattered UHR-LTF involves using an extended P-matrix size that matches the symbol length of the scattered UHR-LTF. This may further involve preparing a larger P-matrix size such as a 16-symbol-based P-matrix in case of 16 symbol long scattered UHR-LTF. For example, referring to FIG. 9, the scattered LTF portion is extended to 16 symbols, and thus all 16 symbols are allocated with LTS. For a single stream case, a 1×16 P-matrix may be applied to the LTS to obtain the extended scattered LTF portion.

The P-matrix (square matrix) may refer to a matrix for example as specified in International Patent Application Publication No. WO 2020/088493, the contents of which are incorporated herein by reference. The P-matrix may be defined according to a Hadamard code and may have the following structure:

$${P}_{16 \times 16} = [ \begin{matrix}{P}_{8 \times 8} & {P}_{8 \times 8} \\ {P}_{8 \times 8} & - {P}_{8 \times 8}\end{matrix} ]$$

$${P}_{8 \times 8} = [ \begin{matrix}{P}_{4 \times 4} & {P}_{4 \times 4} \\ {P}_{4 \times 4} & - {P}_{4 \times 4}\end{matrix} ]$$

$${P}_{4 \times 4} = [ \begin{matrix}1 & - 1 & 1 & 1 \\ 1 & 1 & - 1 & 1 \\ 1 & 1 & 1 & - 1 \\ - 1 & 1 & 1 & 1\end{matrix} ]$$

The extended P-matrix may refer to a portion of a corresponding P-matrix. For example, a (extended) P-matrix of size A×B (where A<B) may refer to the first A rows of the B×B (square) P-matrix.

According to an embodiment, P-matrix is used to extend the scattered LTF portion in a MIMO system using Null Data Packet (NDP) transmissions where the number of receiving antennas (N_{RX}) is greater than the number of transmitting antennas (N_{TX}). For an NDP transmission with an N_{TX}, which may be equivalent to the number of Spatial Streams (N_{STS}), a P-matrix (P_{N}_{_{TX}}×N_{LTF}) is applied to the corresponding LTS. Subsequently, a process involving cyclic delay diversity (CDD) and Q-matrix is applied. CDD may provide a different delay diversity to each stream, so that each stream experiences more independent propagation and thus ends up achieving more diversity gain.

Application of the P-matrix to an LTS can be generally as follows. The LTS, being composed of values “+1” and “−1,” is multiplied by entries of the P-matrix, which is also composed of values “+1+ and “−1.” So, for example, if an entry of “−1” from the P-matrix is applied to an LTF symbol in a certain spatial stream, then, the entire LTS in that symbol and in the stream are negated. A receiver, knowing the P-matrix, can recover the original symbol values as necessary via a similar multiplication operation.

The application of P-Matrix to extend the scattered LTF portion may be adaptable to different configuration shown in the following table:

N_{LTF}

| N_{STS} | VHT/HE | EHT |
|---|---|---|
| 2 | 2 | 2, 4 |
| 4 | 4 | 4, 8 |
| 8 | 8 | 8 |

where the number of LTF symbols (N_{LTF}) may vary depending on the wireless standard as illustrated. As seen in the Table above, the number of LTFs can be twice as many as the number of Space-Time Streams (N_{STS}) in the EHT, for example.

According to an embodiment, the channel estimation of NDP at the receiver may be performed according to the following:

$${H}_{{N}_{R X} x {N}_{T X}} = {Y}_{{N}_{R X} x {N}_{L T F}} {P}_{{N}_{L T F} x {N}_{T X}}^{T} \frac{1}{{N}_{L T F} \cdot LTS}$$

where, H_{N}_{_{RX}}_{×N}_{_{TX}} is the channel estimation matrix, Y_{N}_{_{RX}}_{×N}_{_{LTF}} is the received signal, and P_{N}_{_{LTF}}_{×N}_{_{TX}}^{T} is the transpose of the P-matrix. This channel estimation approach may be based on applying the P-matrix for extending the scattered LTF portion.

According to an embodiment, another method for extending the scattered UHR-LTF is provided. The method involves combining an extended P-matrix with repeated Scattered UHR-LTF symbols. This entails using the extended P-matrix for a specified number of Scattered UHR-LTF symbols and repeating these symbols where the extended P-matrix is applied.

For example, if the number of TX Spatial Streams (N_{SS}) is 2 and there are 16 Scattered UHR-LTF symbols, the extended P-matrix with a size of 2×8 can be applied, repeating the 8-symbol Scattered UHR-LTF where the 2×8 P-matrix has been applied twice, resulting in a total of 16 Scattered UHR-LTF symbols. It is noted that N_{SS} may equal N_{STS} in various implementations. Where the current P-matrix is defined for P_{8×8}, in order to apply the P_{8×8} to 16 LTF symbols, P_{8×8} is applied twice.

In some embodiments, the channel estimation process for the case of 16 symbol Scattered UHR-LTFs involves obtaining the channel estimation H (sized N_{RX}×2, where N_{RX} is the number of RX and “2” represents the number of TX spatial streams.) using the transposed 2×8 P-matrix for the first 8 Scattered UHR-LTF symbols and repeating this process for the second set of 8 Scattered UHR-LTF symbols. The final channel estimation is derived by averaging the two estimated channel parameters obtained separately for the first and second sets of eight Scattered UHR-LTFs.

According to an embodiment, another method for extending the scattered UHR-LTF is provided. The method involves repeating the Scattered UHR-LTF symbols. In some embodiments, where the TX number of streams is equal to N_{SS}, the method includes applying the N_{SS}×N_{SS} P-matrix to the first N_{SS} Scattered UHR-LTF symbols, followed by repeating these N_{SS} Scattered UHR-LTF symbols to match (as far as) the extension of Scattered UHR-LTF symbols in the frame.

For example, in a scenario where the number of TX Spatial Streams (N_{SS}) is 2, and there are 16 Scattered UHR-LTF symbols, the 2×2 P-matrix can be applied to the first two Scattered UHR-LTF symbols. Subsequently, these two-symbol Scattered UHR-LTFs can be repeated eight times to achieve a total of 16 Scattered UHR-LTF symbols.

In some embodiments, channel estimation can be done first by N_{SS}×N_{SS} channel estimation according to or using the standard channel estimation procedure. Averaging is then performed over the number of repeated Scattered UHR-LTFs beyond the first N_{SS} Scattered UHR-LTFs.

In the same scenario (where the number of TX Spatial Streams (N_{SS}) is 2 and the number of Scattered UHR-LTF symbols is 16), measuring the channel estimation is carried out individually for the 1st, 2nd, 3rd, and 4th pairs of Scattered UHR-LTF symbols, followed by averaging these four sets of channel estimation parameters.

Embodiments provide for partially occupying each LTF symbol based on a certain DRU tone position. This approach of partially occupying each LTF symbol may offer ease of implementation. According to some embodiments, the remaining tones within each partially occupied LTF symbol (excluding the LTS positions) can be used or allocated for data transmission. This use of tones for data may result in enhanced throughput.

Embodiments may further provide methods to extend the scattered UHR-LTF. In some embodiments, the scattered UHR-LTF is extended through a combination of extended P-matrix and repetition. In some embodiments, the scattered UHR-LTF is extended through the extended P-matrix only. In some embodiments, the scattered UHR-LTF is extended through the repetition of the basic size of P-matrix based LTFs. Extending the LTF may contribute to improved accuracy in channel estimation.

According to an embodiment, a simulation was conducted based on the following settings: 20 MHz Single-Input Single-Output (SISO) configurations with 52-tone DRUs accommodating 4 scheduled users in 20 MHz, and with 106-tone DRUs serving 2 users in 20 MHz. The simulation compared scenarios involving 4, 8, and 16 SLTF for 52-tone DRUs, as well as 2, 4, 8, and 16 SLTF for 106-tone DRUs. A baseline was established using 1/2/4/8 Regular LTF based Single-User (SU) and SISO transmissions. Receiver Signal-to-Noise Ratio (RX-SNR) was considered, incorporating channel gains into the SNR calculations.

According to an embodiment, a simulation was conducted to evaluate different configurations in a 20 MHz SISO setup, incorporating 52-tone DRUs to support 4 users within the 20 MHz bandwidth, as well as 106-tone DRUs accommodating 2 users in the same bandwidth. The simulation compared the performance of SLTF with varying numbers of SLTFs: 4 SLTFs, 8 SLTFs, and 16 SLTFs for the 52-tone DRUs, and 2 SLTFs, 4 SLTFs, 8 SLTFs, and 16 SLTFs for the 106-tone DRUs. These SLTF configurations were compared against a baseline scenario that utilized 1/2/4/8 regular LTF based SU/SISO transmission scenarios. The evaluation considered receiver Signal-to-Noise Ratio (RX-SNR), taking into account channel gains to determine the Signal-to-Noise Ratio (SNR) during the simulation.

FIG. 3 illustrates a configuration involving 4 Scattered Long Training Fields (SLTF) based on 52-tone DRUs with 16 data symbols, according to an embodiment. Referring to FIG. 3, in the SLTF portion 104, the tones not scheduled to the LTS are allocated for data transmission. For instance, in SLTF 1, DRU 2/3/4 tones may carry data scheduled for STA 2/3/4. Similarly, in SLTF 2, DRU 1/3/4 tones may carry data scheduled for STA 1/3/4.

In some embodiments, the channel estimation process involves recovering channel parameters for specific DRU tone positions within each SLTF. For example, channel parameters for DRU 1 tones are recovered in SLTF 1, those for DRU 2 tones in SLTF 2, and so forth up to SLTF 4. This approach may obviate or eliminate the need for interpolation across all sub-carriers by combining the estimated channel parameters from all 4 SLTFs.

For example, in the case of a single stream based on 52-tone DRU case, 4 SLTF symbols may be needed to estimate channel parameters without interpolation. For the case of 106-tone DRU case, 2 SLTF symbols may be needed to estimate the channel parameters without interpolation. Thus, for each DRU position, the channel parameters may be recovered in a corresponding SLTF symbol. As such, by avoiding interpolation, channel estimation may be improved. In some embodiments, these 4 SLTF symbols may be repeated to further improve channel estimation accuracy via averaging, as described herein.

Within the pure data portion 106 depicted in FIG. 3, there may be various options for tone scheduling. In some embodiments, tone scheduling is performed according to a first option, which involves leaving the same tones which were scheduled for the LTS in the SLTF portion blank without scheduling any data with the same per-tone TX power as the SLTF portion. Accordingly, the tones allocated for the LTS in the SLTF portion remain unoccupied, maintaining the same per-tone TX power as in the SLTF portion. This option may be simple to implement, as may be appreciated.

In some embodiments, tone scheduling is performed according to a second option, which involves leaving the same tones which were scheduled for the LTS in the SLTF portion blank without scheduling any data, but with more boosted per-tone TX power than the SLTF portion. Accordingly, the same tones designated for the LTS in the SLTF portion also remain unoccupied but with a higher per-tone TX power compared to the SLTF segment. For example, in FIG. 3, the per-tone TX power for the scheduled data tones is increased from Pₜ/4 to Pₜ/3 in the pure data portion, where Pₜ represents the TX power being used for every 12 data sub-carriers (“data subcarriers” here mean the tones excluding DC, Edge tones and Null tones (referring to the blank/empty tones as illustrated)).

In some embodiments, tone scheduling is performed according to a third option, which involves scheduling all four STAs across all subcarriers in the pure data portion. In such embodiments, all tones (DRUs) of one or more symbols of the pure data portion 106 may be occupied.

FIG. 4 illustrates a configuration involving 8 SLTF based on 52-tone DRUs with 16 data symbols, according to an embodiment. In this context, the LTS allocation remains the same as that of the 4 SLTF with 16 data symbols case of FIG. 3. As illustrated, the LTS allocation pattern observed in the first 4 SLTFs (SLTFs 1 through SLTF 4) is repeated in the subsequent 4 SLTFs (SLTF 5 through SLTF 8). This approach may enable the recovery of channel parameters using both sets of SLTFs, allowing for averaging to enhance channel estimation accuracy. Similarly, the options described for tone utilization in the pure data portions for the 4 SLTF with 16 data symbols case (as shown in FIG. 3) can be applied to this 8 SLTF with 16 data symbols scenario.

FIG. 5 illustrates a configuration involving 16 SLTFs based on 52-tone DRUs with 16 data symbols, according to an embodiment. The LTS allocation remains the same as that of the 8 SLTFs/16 data symbols case shown in FIG. 4. As illustrated, the LTS allocation pattern from the first 4 SLTFs is repeated across all 16 SLTFs. This strategy may allow for channel parameter recovery using the initial 4 SLTFs and subsequent sets of 4 SLTFs, enhancing channel estimation accuracy through averaging.

For instance, the channel parameter estimation for the first DRU 1 tone position is as follows: h₀=(y₀₀+y₀₄+y₀₈+y₀₁₂)/(4*LTS₀), where h₀ represents the estimated channel parameter at the first DRU 1 tone position, and y₀₄ denotes, for example, the received signal at the first DRU 1 tone position and at the 5th SLTF symbol (SLTF 5).

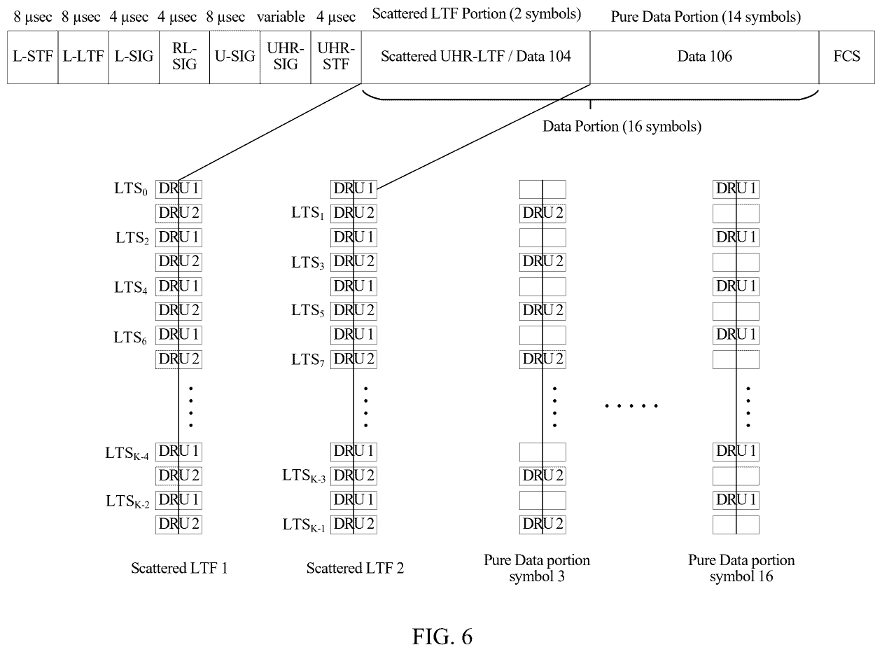

FIG. 6 illustrates a configuration involving 2 SLTFs based on 106-tone DRUs with 16 data symbols, according to an embodiment. Referring to FIG. 6, in the SLTF portion 104, the tones not scheduled to the LTS are allocated for data transmission. For instance, in SLTF 1, DRU 2 tone is scheduled for STA 2. Similarly, in the SLTF 2, tones for DRU1 are scheduled for STA 1.

In some embodiments, the channel estimation process involves recovering channel parameters for specific DRU tone positions within each SLTF. For example, channel parameters for DRU 1 tones are recovered in SLTF 1, and those for DRU 2 tones in SLTF 2. This approach may obviate or eliminate the need for interpolation across all sub-carriers by combining the estimated channel parameters from the two SLTFs.

Within the pure data portion 106 depicted in FIG. 6, there may be various options for tone scheduling. In some embodiments, tone scheduling is performed according to a first option, which involves leaving the same tones which were scheduled for the LTS in the SLTF portion blank without scheduling any data with the same per-tone TX power as the SLTF portion. Accordingly, the tones allocated for the LTS in the SLTF section remain unoccupied, maintaining the same per-tone TX power as in the SLTF segment. This option may be simple to implement, as may be appreciated.

In some embodiments, tone scheduling is performed according to a second option, which involves leaving the same tones which were scheduled for the LTS in the SLTF portion blank without scheduling any data, but with more boosted per-tone TX power than the SLTF portion. Accordingly, the same tones designated for the LTS in the SLTF portion also remain unoccupied but with a higher per-tone TX power compared to the SLTF segment.

In some embodiments, tone scheduling is performed according to a third option, which involves scheduling both STAs across all subcarriers in the pure data portion.

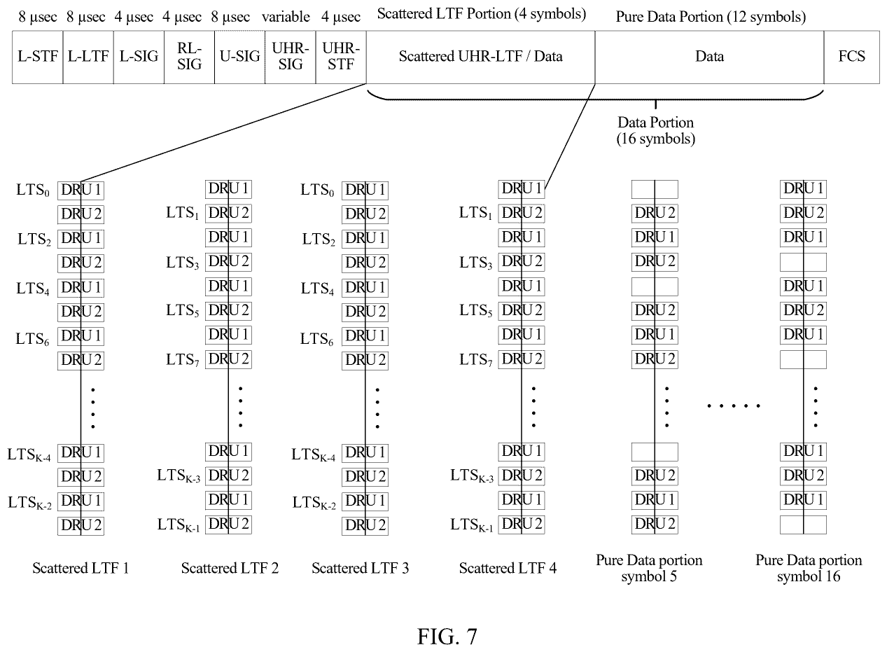

FIG. 7 illustrates a configuration involving 4 SLTFs based on 106-tone DRUs with 16 data symbols, according to an embodiment. In this context, the LTS allocation remains the same as that of the 2 SLTF with 16 data symbols case of FIG. 6. As illustrated, the LTS allocation pattern observed in the first 2 SLTFs is repeated in the subsequent 2 SLTFs (SLTF 3 and SLTF 4). This approach may enable the recovery of channel parameters using both sets of SLTFs (the first 2 SLTFs and the next 2 SLTFs), allowing for averaging to enhance channel estimation accuracy. Similarly, the options described for tone utilization in the pure data portions for the 2 SLTF with 16 data symbols case (as shown in FIG. 6) can be applied to the pure data portion (symbols 5 to 16) of this 4 SLTF with 16 data symbols scenario.

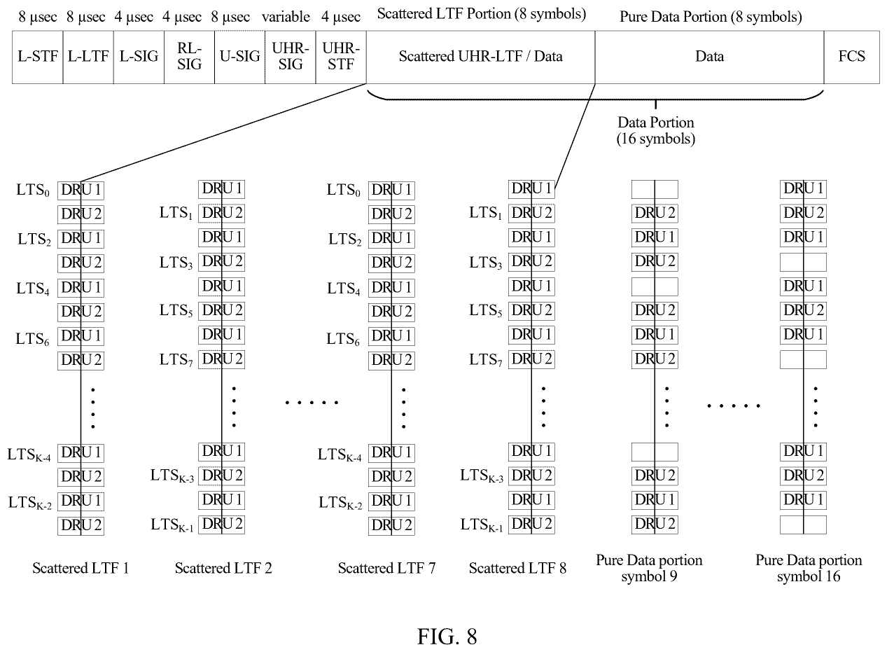

FIG. 8 illustrates a configuration involving 8 SLTF based on 106-tone DRUs with 16 data symbols, according to an embodiment. The LTS allocation in the 8 SLTF/16 data symbols case remains the same as that of the 4 SLTF/16 data symbols case shown in FIG. 7. As illustrated, the LTS allocation pattern from the first 2 SLTFs repeats across all 8 SLTFs, facilitating channel parameter recovery by utilizing the initial two SLTFs and subsequent sets of two SLTFs for averaging, thereby enhancing channel estimation accuracy.

For example, the channel parameter estimation for the first DRU 1 tone position is as follows: h₀=(y₀₀+y₀₂+y₀₄+y₀₆)/(4*LTS₀), where h₀ represents the estimated channel parameter at the first DRU 1 tone position, and y₀₄ denotes the received signal at the first DRU 1 tone position and at the 5th SLTF symbol.

The same options for tone utilization in the pure data portions from the 4 SLTF/16 data symbols case, as described in reference to FIG. 7, can be applied to the pure data portion of this 8 SLTF/16 data symbols case.

FIG. 9 illustrates a configuration involving 16 SLTF based on 106-tone DRUs with 16 data symbols, according to an embodiment. In the 16 SLTF/16 data symbols case, the LTS allocation follows the same pattern as in the 8 SLTF/16 data symbols case of FIG. 8. As illustrated, the LTS allocation from the first 2 SLTFs repeats across all 16 SLTFs, allowing for channel parameter recovery using the initial two SLTFs and subsequent sets of seven two SLTFs for averaging, thereby enhancing channel estimation accuracy.

For instance, the channel parameter estimation for the first DRU 1 tone position is determined as follows: h₀=(y₀₀+y₀₂+y₀₄+y₀₆+y₀₈+y₀₁₀+y₀₁₂+y₀₁₄)/(8*LTS₀), where h₀ represents the estimated channel parameter in the first DRU 1 tone position, and y₀₄ denotes the received signal at the first DRU 1 tone position and at the 5th SLTF symbol.

In some embodiments, tones not allocated with the LTS are instead scheduled with data. In SLTF 1, the remaining tones are scheduled with STA 2 data, while in SLTF 2, they are scheduled with STA 1 data as illustrated. The STA 1 and 2 data are alternately scheduled across all SLTFs, meaning that all DRU 1 tones are scheduled with STA 1 data and all DRU 2 tones are scheduled with STA 2 data when these tones are not allocated with LTS.

It is noted that in all of at least FIGS. 3 to 9, the data portion may be the same length, e.g. 16 OFDM symbols. The data portion may include the SLFT portion and the pure data portion (where present), and the lengths of the SLTF portion and pure data portion may be varied while keeping the data portion the same length.

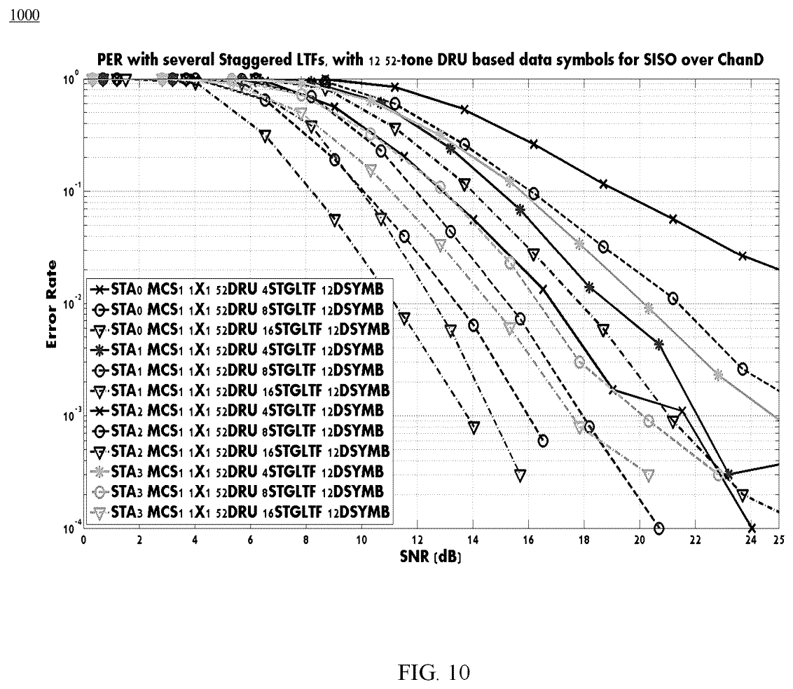

FIG. 10 illustrates performance of several staggered LTFs with 12 52-tone DRU based data symbols in a SISO configuration over variable channel condition, according to an embodiment. Graph 1000 illustrates performance of staggered LTFs (STGLTFs) based on packet error rate (PER) and signal-to-noise ratio (SNR) in decibels (dB). The use of staggered LTFs and data symbol configurations based on 12 52-tone DRU based data symbols is evaluated across channel D. It can be observed that, e.g., for STA₀, as the number of STGLTF is increased, e.g., from 4STGLTF to 8 STGLTF and further to 16 STGLTF case, performance in SNR is improved. Further, LTF overhead may be inhibited.

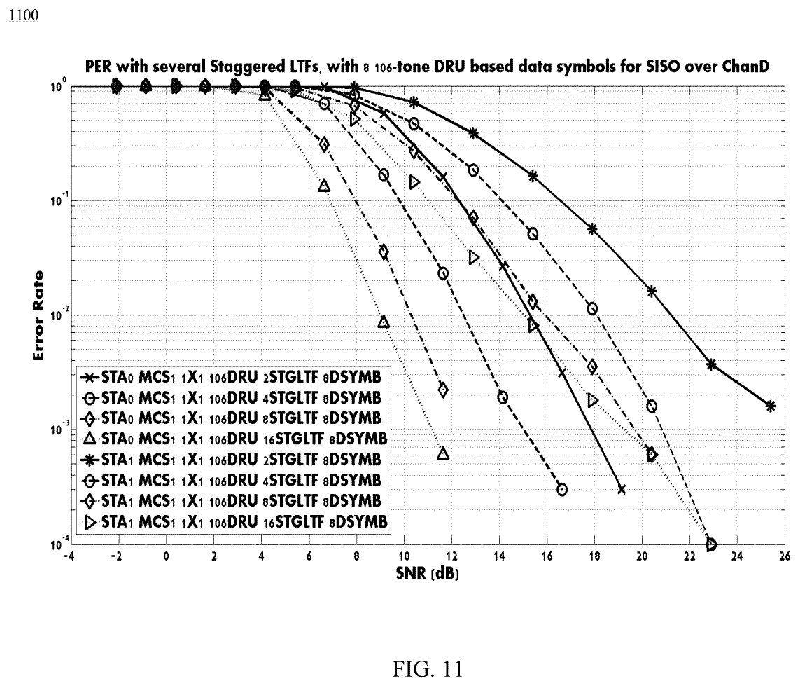

FIG. 11 illustrates performance of several staggered LTFs with 8 106-tone DRU based data symbols in a SISO configuration over variable channel condition, according to an embodiment. Graph 1100 illustrates performance of staggered LTFs based on packet error rate (PER) and signal-to-noise ratio (SNR) in decibels (dB). The use of staggered LTFs and data symbol configurations based on 8 106-tone DRU based data symbols is evaluated across channel D.

Similar to graph 1000, in graph 1100, it can be observed that, e.g., for STA₀, as the number of STGLTF is increased, e.g., from 2STGLTF to 4STGLTF, and further to 8 STGLTF and yet further to 16 STGLTF case, SNR is improved. Further, LTF overhead may be inhibited.

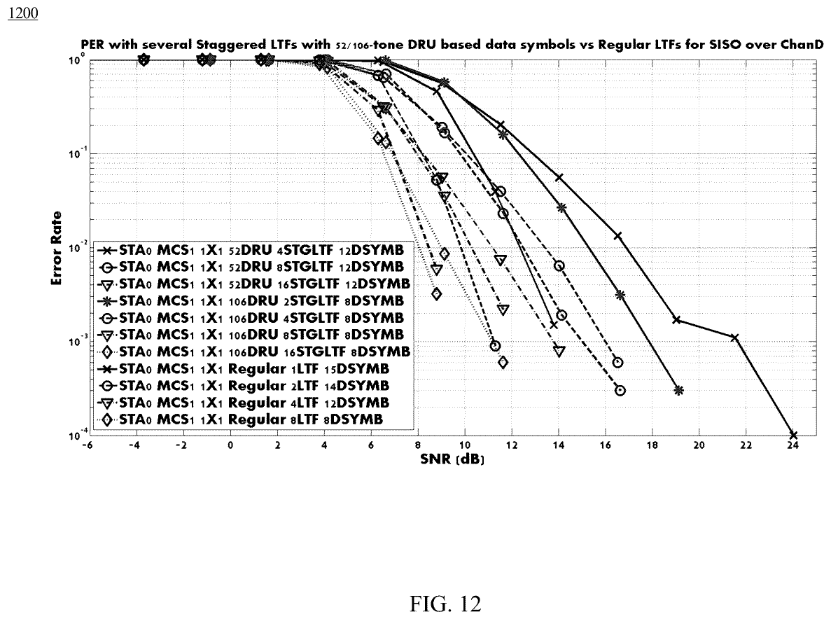

FIG. 12 illustrates a performance comparison between staggered LTFs with regular LTFs (R-LTFs) in a SISO configuration over variable LTF extension, according to an embodiment. Graph 1200 illustrates performance of several staggered LTFs with 52 106-tone DRU based data symbols and performance of regular LTFs over channel D. Graph 1200 indicates data for different Modulation and Coding Scheme (MCS) configurations. For instance, MCS 1 with 52-tone based 12 Data Symbols (DSYMB) transmits 78 bytes per STA without considering TX Power boost. Similarly, MCS 1 with 106-tone based 8 DSYMB transmits 106 bytes per STA, also without considering TX Power boost. The graph also shows the performance of MCS 1 with different numbers of R-LTFs and corresponding DSYMB transmissions, ranging from 1 R-LTF with 15 DSYMB transmitting 450 bytes to 8 R-LTF with 8 DSYMB transmitting 242 bytes. This comparison is relevant for long-range communication scenarios involving short packets, providing insights into the effectiveness of staggered LTFs compared to regular LTFs under various MCS configurations and channel conditions.

Referring to graph 1200, a first comparison may be made with respect to PER. For example, for the regular 8LTF 8DYSMB case (baseline case), the PER is similar to (although slightly better than (˜1.7 dB difference) that of the 52-tone DRU 16STGLTF case (staggered case) not considering that the baseline case has its LTF symbol repeated 8 times, whereas in the staggered case, the SLTF symbols are only repeated 3 times (16STGLTF symbols). Accordingly, increasing the number of STGLTF symbols to match the 8 times repetition of the baseline case, the staggered case may allow for improvement.

Another comparison may be made in terms of transmitted data size. For the 52-tone DRU 4STGLTF case, 78 bytes per STA is transmitted, indicating a total (4 STAs) systems throughput of 78*4=312 bytes. This amount is more than the 242 bytes transmitted for the baseline case. It should be noted that these results are without TX power boost, and without leveraging the blank DRUs in the pure data symbols, which may provide further improvements.

FIGS. 10-12 illustrate performance for staggered LTFs, which refer to a type of scattered LTF in which staggering is implemented as described elsewhere herein. Thus FIGS. 10-12 illustrate performance for certain types of scattered LTFs.

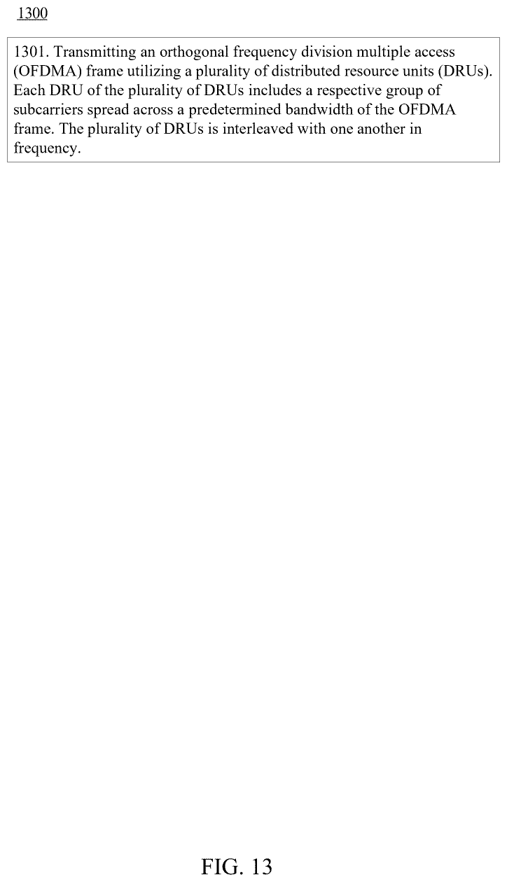

FIG. 13 illustrates a method for transmitting data in a Wireless Local Area Network (WLAN) according to an embodiment. In some embodiments, the method 1300 is performed by an electronic device 1400. Method 1300 includes transmitting 1301 an orthogonal frequency division multiple access (OFDMA) frame 100 utilizing a plurality of distributed resource units (DRUs). Each DRU of the plurality of DRUs includes a respective group of subcarriers spread across a predetermined bandwidth of the OFDMA frame. The plurality of DRUs is interleaved with one another in frequency. The OFDMA frame includes a scattered long training field (SLTF) portion 104 which includes one or more orthogonal frequency division multiplexing (OFDM) symbols (e.g., SLTF symbols 110 or 115) arranged sequentially in time. Each of the OFDM symbols is formed using the plurality of DRUs. Each of the OFDM symbols carries, using a respective one of the DRUs, a respective portion of a long training sequence (LTS) of a long training field (LTF) of the OFDMA frame, and carries data using another respective one or more of the DRUs. The SLTF portion further includes at least two different symbols of the OFDM symbols use different respective ones of the DRUs for carrying the respective portions of the LTS.

In some embodiments, within each respective one of the OFDM symbols, an m^{th} one of the DRUs carries a respective portion of the LTS. The m^{th} DRU is determined according to the formula: m=mod(n−1,M)+1. In the formula n represents a time-sequential position of the respective one of the OFDM symbols within the (e.g. plurality of) OFDM symbols and M represents a total number of the DRUs used in the OFDM frame. Further, m represents a position within a frequency-based ordering of the plurality of DRUs, such that adjacency of two DRUs in the frequency-based ordering corresponds to adjacency, in frequency, of constituent subcarriers of the two DRUs. It can be verified that the above formula for determining the m^{th} DRU within each OFDM symbol can result in a repeating diagonally progressing “checkerboard” pattern” of subcarriers which carry LTS portions, as shown in the drawings, e.g. as in FIGS. 1 and 3 to 9. For example in FIG. 5 M=4, and for n ranging from 1 to 16 the respective values of m are given by the sequence [1, 2, 3, 4, 1, 2, 3, 4, 1, 2, 3, 4, 1, 2, 3, 4], which matches the numbering of DRUs carrying LTS portions. For example, as shown OFDM symbol #1 (n=1) has DRU1 (m=1) carrying LTS portions, OFDM symbol #7 (n=7) has DRU3 (m=3) carrying LTS portions, etc.

In some embodiments, the LTS is formed of a plurality of sequential portions each represented as LTSₖ, with k indexed beginning from 0. In some embodiments, for each k, LTSₖ is carried by a k+1^{st} one of the subcarriers, the subcarriers being ordered sequentially in frequency. In some embodiments, the LTS is repeated according to a (same) pattern, each repetition being carried by a separate respective group of the OFDM symbols. For example, referring again to FIG. 5, LTS₀ is carried by a first (uppermost in the figure) subcarrier, LTS₁ is carried by a second (second row from the top) subcarrier, etc. The rows of subcarriers as shown in the figures represent subcarriers at different successive frequencies, e.g. with frequency incrementing or decrementing with row number.

In some embodiments, the OFDMA frame further includes a pure data portion 106 including one or more further OFDM symbols (e.g., pure data portion symbol 120) carrying data and being devoid of contents of the LTF. In some embodiments, the (e.g. plurality of) OFDM symbols (e.g., STLF symbol 110 or 115) carrying portions of the LTS collectively establish a time-frequency pattern of DRUs according to those DRUs carrying portions of the LTS. This time-frequency pattern is carried over into the pure data portion to define a set of unused DRUs within the one or more further OFDM symbols of the pure data portion.

In some embodiments, transmit power per tone is increased for the one or more further OFDM symbols in response to the unused DRUs. In some embodiments, substantially all data of the OFDMA frame is carried within the SLTF portion.

In some embodiment, the LTS is repeated. In some embodiments, where the LTS is repeated, at least some different instances of the repeated LTS are multiplied by different corresponding entries within a P-matrix or an extended P-matrix. In some embodiments, the one or more OFDM symbols include a first symbol. The first symbol includes a first DRU carrying a portion of the LTS and one or more DRUs other than the first DRU carrying data. In some embodiments, the one or more OFDM symbols further include a second symbol. The second symbol includes a second DRU different from the first DRU, the second DRU carrying another portion of the LTS and one or more DRUs other than the second DRU carrying data.

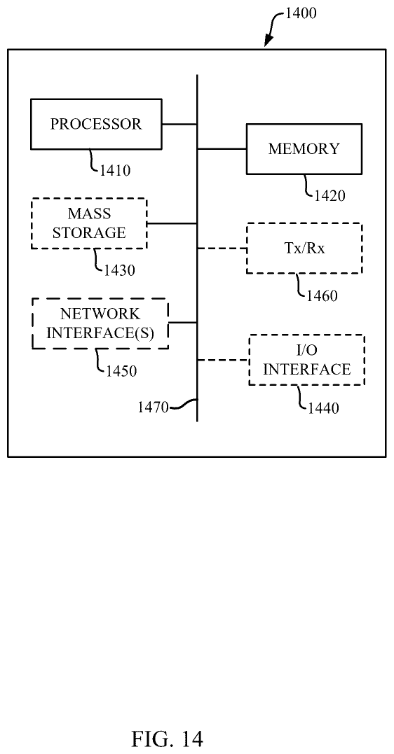

FIG. 14 is a schematic diagram of an apparatus or an electronic device 1400 that may perform any or all of operations of the above methods and features explicitly or implicitly described herein, according to different embodiments of the present application. For example, a computer equipped with network function may be configured as electronic device 1400. In some embodiments, electronic device 1400 can be a device that connects to the network infrastructure over a radio interface, such as a mobile phone, smart phone or other such device that may be classified as user equipment (UE). In some aspects, the electronic device 1400 may be a Machine Type Communications (MTC) device (also referred to as a machine-to-machine (m2m) device), or another such device that may be categorized as a UE despite not providing a direct service to a user. In some embodiments, electronic device 100 is capable of Wi-Fi connectivity, including the transmission and reception of Wi-Fi frames, including OFDMA frames. In some embodiments, electronic device 100 can function as an access point or a station in a Wi-Fi network and is equipped to perform channel estimation for optimizing wireless communication. In some embodiments, electronic device 100 is designed to support Wi-Fi 8 technology and future advancements. In some embodiments, electronic device 100 supports is designed for use in downlink OFDMA or uplink single-user (UL SU) transmission scenarios. In some embodiments, electronic device 1400 may perform one or more operations in one or more embodiments described herein. In some embodiments, the electronic device 1400 may be a UE, an AP, a STA, a transmitter, a receiver, another IEEE 802.11 or Wi-Fi™ device or the like as appreciated by a person skilled in the art.

As shown, the electronic device 1400 may include a processor 1410, such as a Central Processing Unit (CPU) or specialized processors such as a Graphics Processing Unit (GPU) or other such processor unit, memory 1420, non-transitory mass storage 1430, input-output interface 1440, network interface 1450, and a transceiver 1460, all of which are communicatively coupled via bi-directional bus 1470. According to certain embodiments, any or all of the depicted elements may be utilized, or only a subset of the elements. Further, electronic device 1400 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1420 may include any type of non-transitory memory such as static random access memory (SRAM), dynamic random access memory (DRAM), synchronous DRAM (SDRAM), read-only memory (ROM), any combination of such, or the like. The mass storage element 1430 may include any type of non-transitory storage device, such as a solid state drive, hard disk drive, a magnetic disk drive, an optical disk drive, USB drive, or any computer program product configured to store data and machine executable program code. According to certain embodiments, the memory 1420 or mass storage 1430 may have recorded thereon statements and instructions executable by the processor 1410 for performing any of the aforementioned method operations described above.

In some embodiments, the electronic device 1400 may include any suitable structure for generating signals, such as control signals, for wireless transmission to one or more network nodes. In some embodiments apparatus 1400 further includes one or more antennas which may be based on any suitable structure for transmitting and/or receiving wireless signals. The one or more antennas may be coupled to the transceiver 1460.

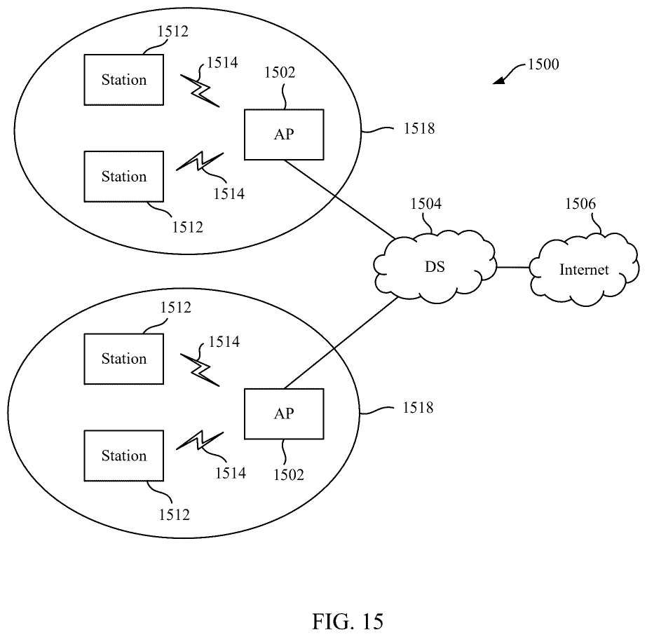

In some embodiments, processor 1410 is configured for performing various processing operations such one or more of: as signal coding, data processing, power control, input/output processing, and any other suitable functionalities to enable the apparatus 1400 to access and join the communication system 1500 (shown FIG. 15) and operate therein.

In some embodiments, the transceiver 1460 may be configured for modulating data or other content for transmission by the at least one antenna to communicate with an AP for example. The transceiver 1460 may also be configured for demodulating data or other content received by the at least one antenna. Each transceiver 1460 may include any suitable structure for generating signals for wireless transmission and/or processing signals received wirelessly. Each antenna may include any suitable structure for transmitting and/or receiving wireless signals. Although shown as a single functional unit, a transceiver 1460 may be implemented separately as at least one transmitter and at least one receiver.

FIG. 15 illustrates a communication system 1500, according to an embodiment of the present application. The communication system 1500 may be a WI-FI system built under relevant standards, such as IEEE 1502. 11 standard, for example, for a WLAN prioritizing UHR. The communication system 1500 includes a plurality of interconnected networking devices 1502, such as a plurality of interconnected access points (APs such as WI-FI 8 APs; which may also be referred to as “base stations”) forming a distribution system (DS) 1504 which is connected to other networks, such as the Internet 1506, which may include a network of computers and subnets (intranets) or both, and incorporate protocols, such as Internet Protocol (IP), Transmission Control Protocol (TCP), User Datagram Protocol (UDP), and/or the like.

Each AP 1502 is in wireless communication with one or more mobile or stationary stations 1512 (STAs) through respective wireless channels 1514 for providing wireless network connections thereto. Herein, the APs 1502 and STAs 1512 may be considered as different types of network nodes (or simply “nodes”) of the communication system 1500. Together, each AP 1502 and the STAs 1512 connected thereto form a cell or basic service set (BSS) 1518.

In embodiments, the STAs 1512 may be any suitable wireless device that may join the communication system 1500 via an AP 1502 for wireless operation. In various embodiments, a STA 1512 may be a wireless electronic device used by a human or user (such as a smartphone, a cellphone, a personal digital assistant (PDA), a laptop, a desktop computer, a tablet, a smart watch, a consumer electronics device, and/or the like). An STA 1512 may be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation or application, the STA 1512 may be movable autonomously or under the direct and/or remote control of a human, or may be positioned at a fixed position.

In some embodiments, an STA 1512 may be a multimode wireless electronic device capable of operation according to multiple radio access technologies and incorporate multiple transceivers necessary to support such.

In embodiments, some or all of the STAs 1512 include functionality for communicating with different wireless devices and/or wireless networks via different wireless links using different wireless technologies and/or protocols. Instead of wireless communication (or in addition thereto), some or all of STAs 1512 may communicate via wired communication channels to other devices or switches (not shown), and to the Internet 1506. For example, a plurality of STAs 1512 (such as STAs 1512 in proximity with each other) may communicate with each other directly via suitable wired or wireless sidelinks.

In the communication between the AP 1502 and the STA 1512, a transmission from the STA 1512 to the AP 1502 may typically be denoted as an uplink (UL), and the wireless channel used therefor is denoted an uplink channel. A transmission from the AP 1502 to the STA 1512 may typically be denoted as a downlink (DL), and the wireless channel used therefor is denoted a downlink channel. Suitable modulation technologies may be used for communication between the AP 1502 and the STA 1512. For example, in some embodiments, orthogonal frequency-division multiplexing (OFDM) may be used wherein the channel 1514 is partitioned into a plurality orthogonal subchannels for communication between the AP 1502 and the STA 1512. In embodiments where a plurality of STAs 1512 is in communication with a same AP 1502, suitable multiple-access technologies may be used. For example, in some embodiments, orthogonal frequency-division multiple access (OFDMA) may be used for communication between the AP 1502 and STAs 1512.

Some wireless communication systems use OFDMA for multiple access. Generally, OFDMA uses OFDM for multiple users to transmit data at the same time.

For example, a device, such as an AP 1502 or an STA 1512, transmits data using PPDUs. A PPDU contains a preamble and a data field containing an OFDM symbol. As readily understood by a person skilled in the art, an OFDM symbol combines data elements into a plurality of subcarriers (also referred to as “tones”) and uses the so-called “cyclic prefix” for combating inter-symbol interferences.

In embodiments, the wireless communication system 1500 or more specifically a one or more AP 1502 or one or more STA 1512 thereof may use DRUs that may include non-consecutive subcarriers or tones that substantially span the whole BW. Thus, the subcarriers of the DRU may be allocated across the entire OFDMA BW.

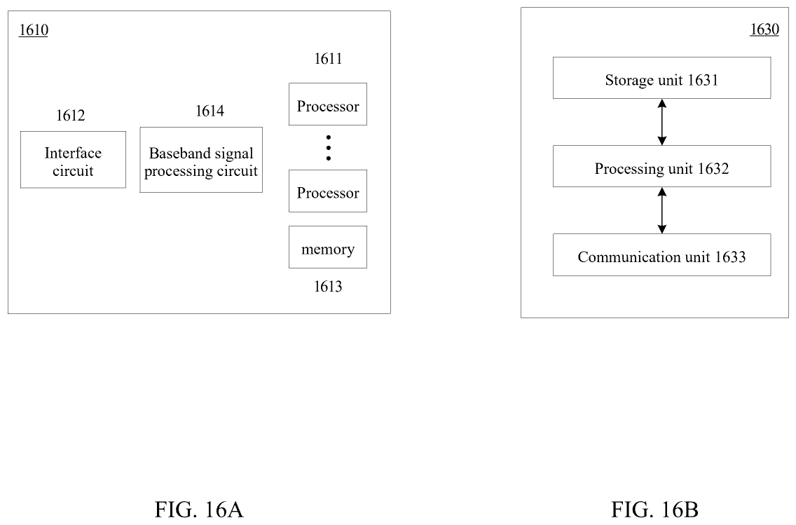

FIG. 16A illustrates an example apparatus 1610, according to an embodiment of the present application. The apparatus 1610 may be a communication device or an apparatus implemented in a communication device in one or more embodiments described herein. For example, the apparatus implemented in a communication device may be an integrated circuit, which in some contexts may be known by other colloquial names, such as chip, modem, modem chip, baseband chip, or baseband processor. In some implementations, one or more integrated circuits can be packaged into a system-on-chip, a system-in-package, or a multi-chip module. The apparatus may comprise one or more integrated circuits or comprise one or more integrated circuits and other discrete components. In some implementations, the apparatus 1610 may be similar to or a module in apparatus 1400.

In an example, the apparatus 1610 may include one or more processors/processor cores 1611, and an interface circuit 1612. The apparatus 1610 may further include a memory 1613. The one or more processors/processor cores 1611 are configured to process signals and execute one or more communication protocols. The memory 1613 is configured to store at least a part of corresponding computer program instructions and/or data. In an example, the one or more processors (or processor cores) 1611 execute the computer program instructions stored in the memory 1613 to implement related operations (for example, inputting, outputting, receiving, and transmitting) in the foregoing method embodiments. In some implementations, the memory 1613 being configured to store the corresponding computer program instructions and/or data may mean that the memory 1613 is configured to store all of the corresponding computer program instructions and/or data for execution by the one or more processors/processor cores 1611. In some implementations, the memory 1613 being configured to store the corresponding computer program instructions and/or data may mean that the memory 1613 is configured to store a part of the corresponding computer program instructions and/or data. For example, the part of the corresponding computer program instructions and/or data include computer program instructions and/or data that need to be currently executed by the one or more processors/processor cores 1611. Thus, the memory 1613 may store different parts of computer program instructions and/or data for a plurality times for the one or more processors (or processor cores) 1611 to perform related operations in the foregoing method embodiments. As a communication interface, the interface circuit 1612 is configured to implement communication with another component. For example, the interface circuit 1612 may communicate a signal with other apparatus/system such as a radio frequency processing apparatus, or processor system. Optionally, to reduce a load of the processor core, a baseband signal processing circuit 1614 may be also disposed to implement processing of at least a part of baseband signals, including signal demodulation, modulation, encoding, decoding, or the like.

Apparatus 1610 may be processor 1410 in apparatus 1400, in some scenario, or included in processor 1410 in apparatus 1400. Apparatus 1610 may be or include a baseband chip. In some implementations, the apparatus 1610 may be independently packaged into a chip. In some implementations, the apparatus 1400 includes different types of chips. The apparatus 1610 may be packaged into a processor chip (for example, a SoC chip or an SIP chip) with the different types of chips. In some implementations, the apparatus 1610 may be packaged into a chip with some or all of circuits of a radio frequency processing system that may further included in the apparatus 1400.

FIG. 16B illustrates another example apparatus 1630, according to an embodiment of the present application. Apparatus 1630 may include corresponding modules or units configured to implement methods and/or embodiments described herein. In some implementations, the apparatus 1630 includes a processing unit 1632 and a communication unit 1633. Optionally, the apparatus 1630 may further include a storage unit 1611 configured to store apparatus program code (or instructions) and/or data.

In some embodiments, the apparatus 1630 may be a module, or a circuit or a chip responsible for a communication function in apparatus 1400. In some implementations, apparatus 1630 may be implemented as apparatus 1400, accordingly, the processing unit 1632 is implemented as processor 1410, the communication unit 1633 is implemented as transceiver 1460, and the storage unit 1631 is implemented as memory 1420.

In some implementations, a function of the apparatus 1630 may be implemented by one or more processors. Specifically, the processor may include a modem chip, or a system on chip SoC chip or an SIP chip that includes a modem core. A function of the communication unit 1633 may be implemented by a transceiver circuit.

In some implementations, when the apparatus 1630 is a circuit or a chip that is responsible for a communication function, for example, a modem chip, a system on chip SoC chip or an SIP chip that includes a modem core, a function of the processing unit 1632 may be implemented by a circuit system that is in the chip and that includes one or more processors or processor cores. A function of the communication unit 1633 may be implemented by an interface circuit or a data transceiver circuit on the foregoing chip.

It may be understood that division into the units in the foregoing apparatus is merely logical function division. Each function may correspond to one functional unit, or two or more functions may be integrated into one functional unit. In actual implementation, all or some of the units may be integrated into one physical entity, or may be distributed in different physical entities. In addition, the foregoing functional units may be implemented in a form of hardware, may be implemented in a form of software, or may be implemented in a form of a combination of hardware and software.

In the present disclosure, the terms “a” or “an” are defined to mean “at least one”, that is, these terms do not exclude a plural number of items, unless stated otherwise.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in different embodiments of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

In some embodiments, this application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device and enable a machine to execute the instructions. When executed by any computer or the processor of a programmable data processing device, the instructions cause the apparatus to implement specific functions as described in one or more procedures in the flowcharts and/or one or more blocks in the block diagrams. The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or on another programmable device provide steps for implementing specific functions as described in one or more procedures in the flowcharts and/or one or more blocks in the block diagrams.

Embodiments of the present application can be implemented using electronics hardware, software, or a combination thereof. In some embodiments, the application is implemented by one or multiple computer processors executing program instructions stored in memory. In some embodiments, the application is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the application as defined by the appended claims, and are contemplated to cover any and all modifications, variations, combinations or equivalents that fall within the scope of the present application. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present application may be implemented by using hardware only or by using software and a necessary universal hardware platform. Based on such understandings, the technical solution of the present application may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present application. For example, such an execution may correspond to a simulation of the logical operations as described herein. The software product may additionally or alternatively include a number of instructions that enable a computer device to execute operations for configuring or programming a digital logic apparatus in accordance with embodiments of the present application.

Although the present application has been described with reference to specific features and embodiments thereof, it is evident that various modifications and combinations can be made thereto without departing from the application. The specification and drawings are, accordingly, to be regarded simply as an illustration of the application as defined by the appended claims, and are contemplated to cover any and all modifications, variations, combinations or equivalents that fall within the scope of the present application.

What is claimed is:

1. A method for transmitting data in a Wireless Local Area Network (WLAN), the method comprising, by an electronic device:
transmitting an orthogonal frequency division multiple access (OFDMA) frame utilizing a plurality of distributed resource units (DRUs) each comprising a respective group of subcarriers spread across a predetermined bandwidth of the OFDMA frame, the plurality of DRUs interleaved with one another in frequency,
the OFDMA frame comprising a scattered long training field (SLTF) portion which includes:
one or more orthogonal frequency division multiplexing (OFDM) symbols arranged sequentially in time, wherein:
each of the OFDM symbols is formed using the plurality of DRUs;
each of the OFDM symbols carries, using a respective one of the plurality of DRUs, a respective portion of a long training sequence (LTS) of a long training field (LTF) of the OFDMA frame, and carries data using another respective one or more of the plurality of DRUs; and
at least two different symbols of the OFDM symbols use different respective ones of the plurality of DRUs for carrying the respective portions of the LTS.

2. The method of claim 1, wherein:
within each respective one of the OFDM symbols, an m^{th} one of the plurality of DRUs carries a respective portion of the LTS, where m=mod(n−1,M)+1;
n represents a time-sequential position of the respective one of the OFDM symbols within the one or more OFDM symbols;
M represents a total number of the DRUs used in the OFDMA frame; and
m represents a position within a frequency-based ordering of the plurality of DRUs, such that adjacency of two DRUs in the frequency-based ordering corresponds to adjacency, in frequency, of constituent subcarriers of the two DRUs.

3. The method of claim 2, wherein the LTS is formed of a plurality of sequential portions each represented as LTSₖ, with k indexed beginning from 0, and wherein, for each k, LTSₖ is carried by a k+1^{st} one of the subcarriers, the subcarriers being ordered sequentially in frequency.

4. The method of claim 3, wherein the LTS is repeated according to a pattern, each repetition being carried by a separate respective group of the OFDM symbols.

5. The method of claim 1, wherein the OFDMA frame further comprises a pure data portion having one or more further OFDM symbols carrying data and being devoid of contents of the LTF.

6. The method of claim 5, wherein the one or more OFDM symbols carrying portions of the LTS collectively establish a time-frequency pattern of DRUs defined by instances of the DRUs carrying portions of the LTS, this time-frequency pattern being carried over into the pure data portion to define a set of unused DRUs within the one or more further OFDM symbols of the pure data portion.

7. The method of claim 6, wherein transmit power per tone is increased for the one or more further OFDM symbols in response to the unused DRUs.

8. The method of claim 1, wherein substantially all data of the OFDMA frame is carried within the SLTF portion.

9. The method of claim 1, wherein the LTS is repeated.

10. The method of claim 1, wherein the LTS is repeated, and wherein at least some different instances of the repeated LTS are multiplied by different corresponding entries within a P-matrix or an extended P-matrix.

11. The method of claim 1, wherein the one or more OFDM symbols include:
a first symbol having a first DRU carrying a portion of the LTS and one or more DRUs other than the first DRU carrying data; and
a second symbol having a second DRU different from the first DRU, the second DRU carrying another portion of the LTS and one or more DRUs other than the second DRU carrying data.

12. An apparatus, in an IEEE 802.11 transmitter, the apparatus configured to:
transmit an orthogonal frequency division multiple access (OFDMA) frame utilizing a plurality of distributed resource units (DRUs) each comprising a respective group of subcarriers spread across a predetermined bandwidth of the OFDMA frame, the plurality of DRUs interleaved with one another in frequency,
the OFDMA frame comprising a scattered long training field (SLTF) portion which includes:
one or more orthogonal frequency division multiplexing (OFDM) symbols arranged sequentially in time, wherein:
each of the OFDM symbols is formed using the plurality of DRUs;
each of the OFDM symbols carries, using a respective one of the plurality of DRUs, a respective portion of a long training sequence (LTS) of a long training field (LTF) of the OFDMA frame, and carries data using another respective one or more of the plurality of DRUs; and
at least two different symbols of the OFDM symbols use different respective ones of the plurality of DRUs for carrying the respective portions of the LTS.

13. The apparatus of claim 12, wherein:
within each respective one of the OFDM symbols, an m^{th} one of the plurality of DRUs carries a respective portion of the LTS, where m=mod(n−1,M)+1;
n represents a time-sequential position of the respective one of the OFDM symbols within the one or more OFDM symbols;
M represents a total number of the DRUs used in the OFDMA frame; and
m represents a position within a frequency-based ordering of the plurality of DRUs, such that adjacency of two DRUs in the frequency-based ordering corresponds to adjacency, in frequency, of constituent subcarriers of the two DRUs.

14. The apparatus of claim 13, wherein the LTS is formed of a plurality of sequential portions each represented as LTSₖ, with k indexed beginning from 0, and wherein, for each k, LTSₖ is carried by a k+1^{st} one of the subcarriers, the subcarriers being ordered sequentially in frequency.

15. The apparatus of claim 14, wherein the LTS is repeated according to a pattern, each repetition being carried by a separate respective group of the OFDM symbols.

16. The apparatus of claim 12, wherein the OFDMA frame further comprises a pure data portion having one or more further OFDM symbols carrying data and being devoid of contents of the LTF.

17. The apparatus of claim 16, wherein the one or more OFDM symbols carrying portions of the LTS collectively establish a time-frequency pattern of DRUs defined by instances of the DRUs carrying portions of the LTS, this time-frequency pattern being carried over into the pure data portion to define a set of unused DRUs within the one or more further OFDM symbols of the pure data portion.

18. The apparatus of claim 17, wherein transmit power per tone is increased for the one or more further OFDM symbols in response to the unused DRUs.

19. The apparatus of claim 12, wherein substantially all data of the OFDMA frame is carried within the SLTF portion.

20. The apparatus of claim 12, wherein the LTS is repeated.

21. The apparatus of claim 20 wherein at least some different instances of the repeated LTS are multiplied by different corresponding entries within a P-matrix or an extended P-matrix.

22. The apparatus of claim 12, wherein the one or more OFDM symbols include:
a first symbol having a first DRU carrying a portion of the LTS and one or more DRUs other than the first DRU carrying data; and
a second symbol having a second DRU different from the first DRU, the second DRU carrying another portion of the LTS and one or more DRUs other than the second DRU carrying data.

23. A non-transitory computer readable medium having recorded thereon instructions which, when executed by a computer, cause the computer to perform the method according to claim 1.
